(19) United States
(12) Patent Application Publication
(10) Pub. No.: US 2023/0314549 A1
(43) Pub. Date: Oct. 5, 2023

(54) TWO-WAY ULTRA-WIDEBAND SENSING

(71) Applicant: QUALCOMM Incorporated, San Diego, CA (US)

(72) Inventors: Pooria PAKROOH, San Diego, CA (US); Bin TIAN, San Diego, CA (US); Stephen Jay SHELLHAMMER, Ramona, CA (US); Ishaque Ashar KADAMPOT, San Diego, CA (US)

(21) Appl. No.: 17/806,598

(22) Filed: Jun. 13, 2022

Related U.S. Application Data
(60) Provisional application No. 63/362,079, filed on Mar. 29, 2022.

(51) Int. Cl. G01S 5/02; H04B 1/7163

(52) U.S. Cl. CPC G01S 5/0268; H04B 1/7163

(57) ABSTRACT

Various aspects of the present disclosure generally relate to wireless communication. In some aspects, an initiator network node may transmit a first sensing signal for sensing an object using ultra-wideband sensing. The initiator network node may receive, from a responder network node, a second sensing signal, that is based at least in part on the first sensing signal, for sensing the object using the ultra-wideband sensing. The initiator network node may obtain a location of the object relative to the initiator network node and the responder network node based at least in part on the first sensing signal and the second sensing signal. Numerous other aspects are described.

### CROSS-REFERENCE TO RELATED APPLICATION

This Patent Application claims priority to U.S. Provisional Patent Application No. 63/362,079, filed on Mar. 29, 2022, entitled “TWO-WAY ULTRA-WIDEBAND SENSING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for two-way ultra-wideband sensing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LIE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an initiator network node. The method may include transmitting a first sensing signal for sensing an object using ultra-wideband sensing. The method may include receiving, from a responder network node, a second sensing signal, that is based at least in part on the first sensing signal, for sensing the object using the ultra-wideband sensing. The method may include obtaining a location of the object relative to the initiator network node and the responder network node based at least in part on the first sensing signal and the second sensing signal.

Some aspects described herein relate to a method of wireless communication performed by a responder network node. The method may include receiving, from an initiator network node, a first sensing signal for sensing an object using ultra-wideband sensing. The method may include transmitting, to the initiator network node, a second sensing signal, that is based at least in part on the first sensing signal, for sensing the object using the ultra-wideband sensing.

Some aspects described herein relate to an apparatus for wireless communication performed by an initiator network node. The apparatus may include a memory and one or more processors, coupled to the memory. The one or more processors may be configured to receive, from a responder network node, a second sensing signal, that is based at least in part on the first sensing signal, for sensing the object using the ultra-wideband sensing. The one or more processors may be configured to obtain a location of the object relative to the initiator network node and the responder network node based at least in part on the first sensing signal and the second sensing signal.

Some aspects described herein relate to an apparatus for wireless communication performed by a responder network node. The apparatus may include a memory and one or more processors, coupled to the memory. The one or more processors may be configured to receive, from an initiator network node, a first sensing signal for sensing an object using ultra-wideband sensing. The one or more processors may be configured to transmit, to the initiator network node, a second sensing signal, that is based at least in part on the first sensing signal, for sensing the object using the ultra-wideband sensing.

Some aspects described herein relate to a non-transitory computer-readable medium that stores a set of instructions for wireless communication by an initiator network node. The set of instructions, when executed by one or more processors of the initiator network node, may cause the initiator network node to transmit a first sensing signal for sensing an object using ultra-wideband sensing. The set of instructions, when executed by one or more processors of the initiator network node, may cause the initiator network node to receive, from a responder network node, a second sensing signal, that is based at least in part on the first sensing signal, for sensing the object using the ultra-wideband sensing. The set of instructions, when executed by one or more processors of the initiator network node, may cause the initiator network node to obtain a location of the object relative to the initiator network node and the responder network node based at least in part on the first sensing signal and the second sensing signal.

Some aspects described herein relate to a non-transitory computer-readable medium that stores a set of instructions for wireless communication by a responder network node. The set of instructions, when executed by one or more processors of the responder network node, may cause the responder network node to receive, from an initiator network node, a first sensing signal for sensing an object using ultra-wideband sensing. The set of instructions, when executed by one or more processors of the responder network node, may cause the responder network node transmit, to the initiator network node, a second sensing signal, that is based at least in part on the first sensing signal, for sensing the object using the ultra-wideband sensing.

Some aspects described herein relate to an apparatus for wireless communication. The apparatus may include means for transmitting a first sensing signal for sensing an object using ultra-wideband sensing. The apparatus may include means for receiving, from a responder network node, a second sensing signal, that is based at least in part on the first sensing signal, for sensing the object using the ultra-wideband sensing. The apparatus may include means for obtaining a location of the object relative to the apparatus and the responder network node based at least in part on the first sensing signal and the second sensing signal.

Some aspects described herein relate to an apparatus for wireless communication. The apparatus may include means for receiving, from an initiator network node, a first sensing signal for sensing an object using ultra-wideband sensing. The apparatus may include means for transmitting, to the initiator network node, a second sensing signal, that is based at least in part on the first sensing signal, for sensing the object using the ultra-wideband sensing.

Aspects generally include a method, apparatus, system, computer program product, non-transitory computer-readable medium, user equipment, base station, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated network node architecture, in accordance with the present disclosure.

FIG. 4 is a diagram illustrating an example of ultra-wideband (UWB) sensing, in accordance with the present disclosure.

FIG. 5 is a diagram illustrating an example associated with two-way UWB sensing, in accordance with the present disclosure.

FIG. 6 is a diagram illustrating an example associated with arrival paths for two-way UWB sensing, in accordance with the present disclosure.

FIG. 7 is a diagram illustrating an example associated with a first approach for interpolation, in accordance with the present disclosure.

FIG. 8 is a diagram illustrating an example associated with a second approach for interpolation, in accordance with the present disclosure.

FIG. 9 is a diagram illustrating an example associated with a locus for an object location, in accordance with the present disclosure.

FIGS. 10A, 10B, and 10C are diagrams illustrating examples associated with resolving object location ambiguity, in accordance with the present disclosure.

FIG. 11 is a diagram illustrating an example process associated with two-way UWB sensing, in accordance with the present disclosure.

FIG. 12 is a diagram illustrating an example process associated with two-way UWB sensing, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

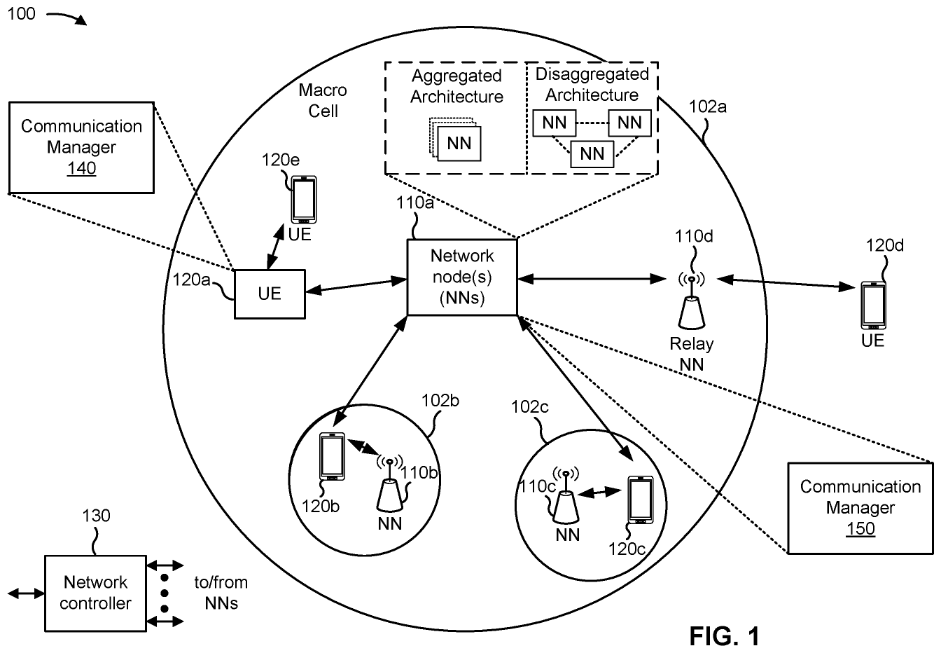

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an initiator network node may include a communication manager 140. As described in more detail elsewhere herein, the communication manager 140 may transmit a first sensing signal for sensing an object using ultra-wideband sensing; receive, from a responder network node, a second sensing signal, that is based at least in part on the first sensing signal, for sensing the object using the ultra-wideband sensing; and obtain a location of the object relative to the initiator network node and the responder network node based at least in part on the first sensing signal and the second sensing signal Additionally, or alternatively, the communication manager 140 may perform one or more other operations described herein.

In some aspects, the responder network node may include a communication manager 140. As described in more detail elsewhere herein, the communication manager 140 may receive, from an initiator network node, a first sensing signal for sensing an object using ultra-wideband sensing; and transmit , to the initiator network node, a second sensing signal, that is based at least in part on the first sensing signal, for sensing the object using the ultra-wideband sensing. Additionally, or alternatively, the communication manager 140 may perform one or more other operations described herein.

As indicated above, FIG. 1 is provided as an example. Other examples may differ from what is described with regard to FIG. 1.

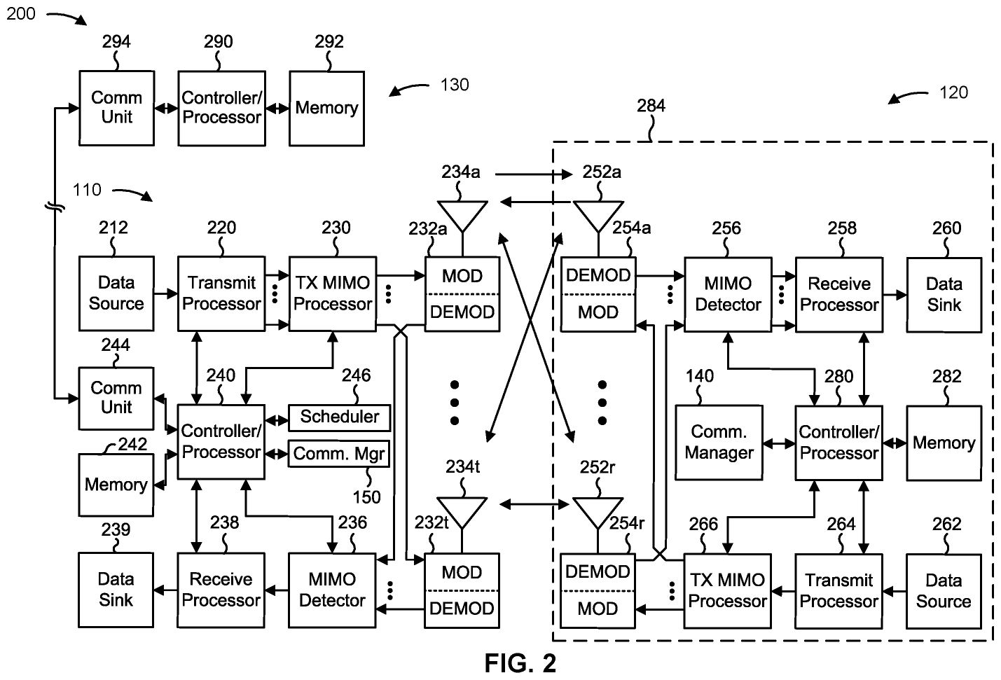

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T>1). The UE 120 may be equipped with a set of antennas 252a through 252r, such as R antennas (R>1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e g , R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

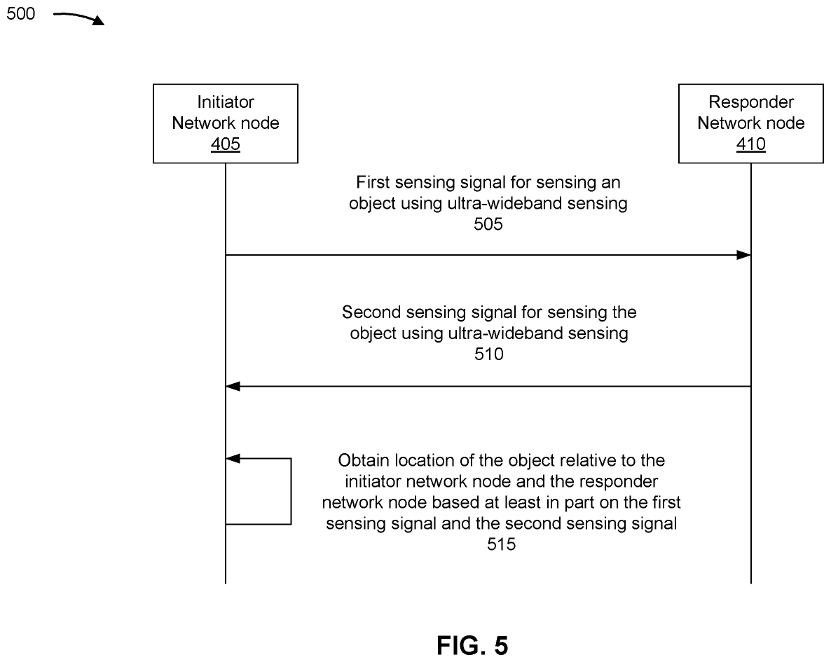

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

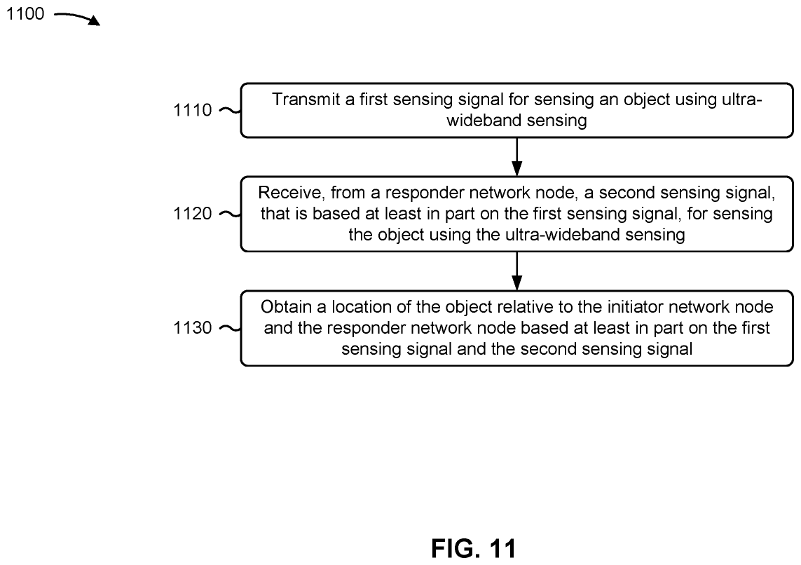

The controller/processor 240 of the network node 110, the controller/processor 280 of the UE 120, and/or any other component(s) of FIG. 2 may perform one or more techniques associated with two-way ultra-wideband (UWB) sensing, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, and/or other processes as described herein. In some examples, executing instructions may include running the instructions, converting the instructions, compiling the instructions, and/or interpreting the instructions, among other examples.

In some aspects, an initiator network node includes means for transmitting a first sensing signal for sensing an object using ultra-wideband sensing; means for receiving, from a responder network node, a second sensing signal, that is based at least in part on the first sensing signal, for sensing the object using the ultra-wideband sensing; and/or means for obtaining a location of the object relative to the initiator network node and the responder network node based at least in part on the first sensing signal and the second sensing signal. In some aspects, the means for the initiator network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a responder network node includes means for receiving, from an initiator network node, a first sensing signal for sensing an object using ultra-wideband sensing; and/or means for transmitting, to the initiator network node, a second sensing signal, that is based at least in part on the first sensing signal, for sensing the object using the ultra-wideband sensing. In some aspects, the means for the responder network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

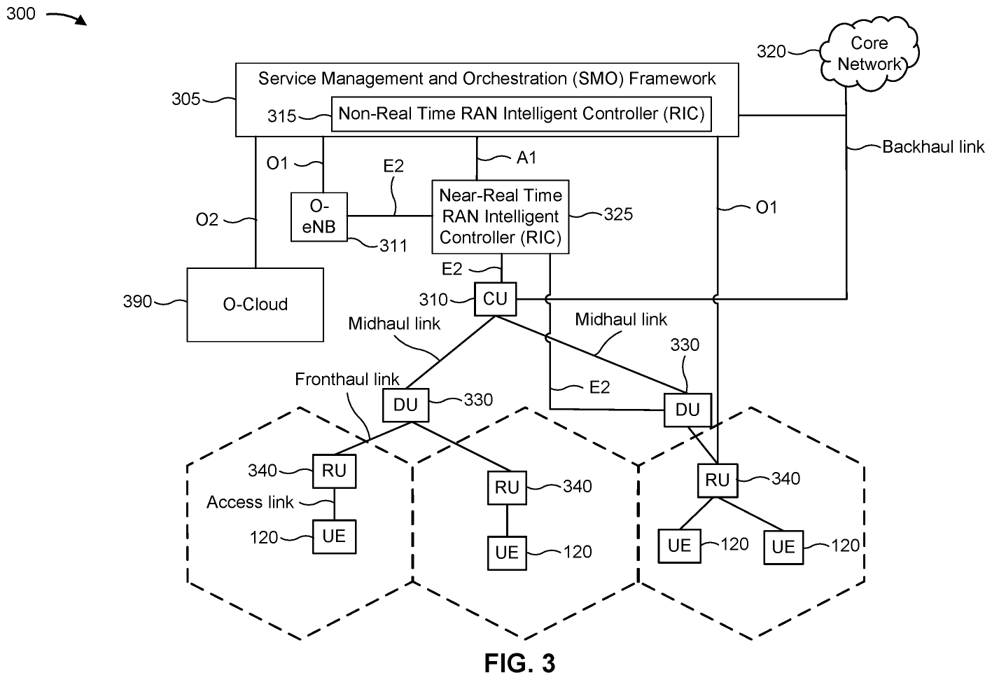

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML, models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

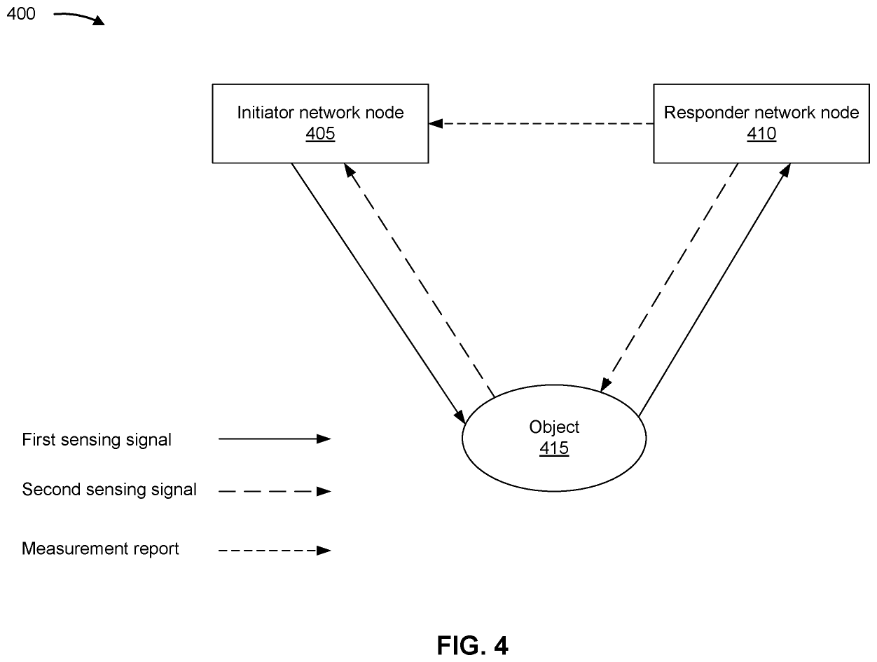

FIG. 4 is a diagram illustrating an example 400 of ultra-wideband (UWB) sensing, in accordance with the present disclosure.

In some cases, UWB technology may be used to transmit signals with wide bandwidth (e.g., >=500 MHz). Signal energy may be transmitted without interfering with narrowband and carrier wave transmission in the same frequency band. UWB may be used for low-energy, short-range applications (e.g., for ranging). In some cases, UWB may be divided into channels 1-15 spanning frequencies from about 3.5 GHz to about 4.5 GHz and from about 6.5 GHz to about 10 GHz.

In some cases, an initiator, such as the initiator network node 405 shown in FIG. 4, may be a sensing device that initiates RF sensing with one or more other UWB devices.

In some cases, a responder, such as the responder network node 410 shown in FIG. 4, may be a sensing device that responds to the initiator.

In some cases, a sensing transmitter may be a sensing device that sends a channel sounding physical protocol data unit (PPDU) to enable channel estimation for RF sensing purposes. In some cases, the sensing transmitter may be the initiator network node 405 or the responder network node 410.

In some cases, a sensing receiver may be a sensing device that receives the channel sounding PPDU from the sensing transmitter and performs channel estimation. In some cases, the sensing receiver may be the initiator network node 405 or the responder network node 410.

In some cases, the initiator network node 405 may be a sensing transmitter and/or a sensing receiver. In some cases, responder network node 410 may be a sensing transmitter and/or a sensing receiver.

In some cases, the initiator network node 405 and/or the responder network node 410 may perform channel impulse response (CIR) measurements. The initiator network node 405 and/or the responder network node 410 may transmit a CIR measurement report for upper layer processing.

In some cases, the CIR may represent a change in a signal as it travels between devices. For example, the CIR may indicate a change in a sensing signal as it travels over a channel between the initiator network node 405 and the responder network node 410. In some cases, the CIR may include a path loss. The path loss may indicate an amount of energy that is lost while the signal is going through the channel. In some cases, the CIR may include a delay spread. The delay spread may indicate how much the signal is dispersed in a time domain while the signal is going through the channel. In some cases, the CIR may include an angle of arrival. The angle of arrival may indicate how the nature of the signal (e.g., the received power and phase) changes with the angle of the receiver antenna and a reference point.

In some cases, the initiator network node 405 and/or the responder network node 410 may be configured for bi-static two-way sensing. Bi-static sensing may involve sensing operations that involve a transmitter and a receiver, such as the initiator network node 405 and the responder network node 410. Two-way sensing may involve sensing operations by devices transmitting and receiving sensing information. For example, the initiator network node 405 may transmit, and the responder network node 410 may receive, a first sensing signal, and the responder network node 410 may transmit, and the initiator network node 405 may receive, a second sensing signal. However, bi-static two-way sensing devices may not be able to determine a location of the object 415 using the bi-static two-way sensing.

Techniques and apparatuses are described herein for two-way UWB sensing. In some aspects, an initiator network node may transmit, and a responder network node may receive, a first sensing signal for sensing an object using UWB sensing. The responder network node may transmit, and the initiator network node may receive, a second sensing signal, that is based at least in part on the first sensing signal, for sensing the object using UWB sensing. The initiator network node and/or the responder network node may obtain a location of the object relative to the initiator network node and the responder network node based at least in part on the first sensing signal and the second sensing signal.

As described above, sensing may be used for determining a range of an object from a device. However, bi-static two-way sensing devices may not be able to determine a location of the object using the bi-static two-way sensing. Using the techniques and apparatuses described herein, the initiator network node and the responder network node may be configured to use the bi-static two-way sensing for determining a location of the object. For example, the initiator network node and the responder network node may use estimation results, such as an angle of arrival (AoA) estimate, relative to the initiator network node and the responder network node, for localization. Additional sensing operations may be used to improve the signal-to-noise ratio (SNR) and to determine an object location with a high degree of accuracy.

As indicated above, FIG. 4 is provided as an example. Other examples may differ from what is described with regard to FIG. 4.

FIG. 5 is a diagram illustrating an example 500 of two-way UWB sensing, in accordance with the present disclosure.

As shown in connection with reference number 505, the initiator network node 405 may transmit, and the responder network node 410 may receive, a first sensing signal for sensing an object using UWB sensing. In some aspects, the first sensing signal may be a first sensing packet or a first sensing frame.

In some aspects, the responder network node 410, based at least in part on receiving the first sensing signal, may estimate a CIR for the first sensing signal. For example, the responder network node 410 may estimate a path loss, a delay spread, or an AoA associated with the first sensing signal.

In some aspects, the responder network node 410 may detect a first arrival path based at least in part on the first sensing signal

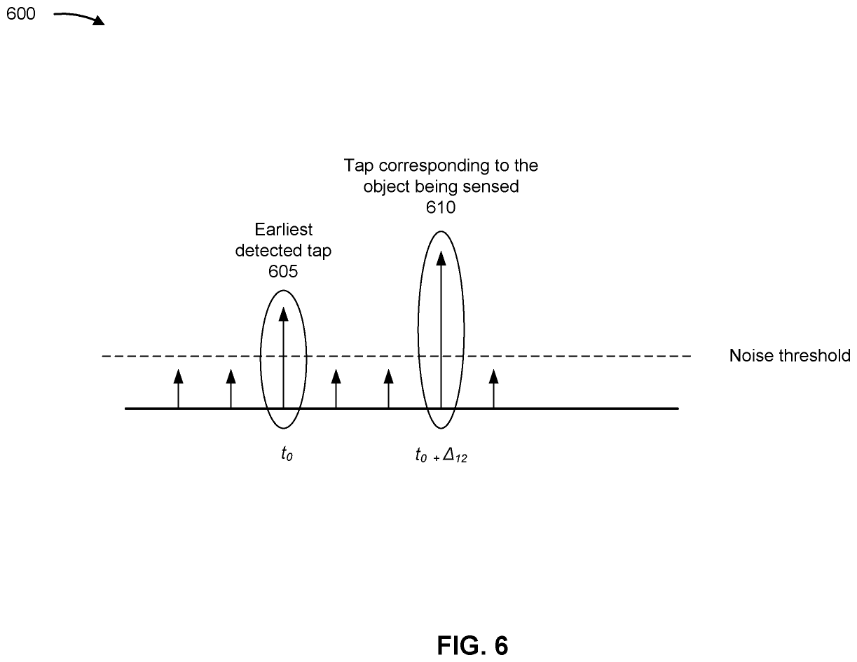

In some aspects, the responder network node 410 may detect another arrival path based at least in part on the first sensing signal interacting with the object 415. For example, the responder network node 410 may detect another arrival path corresponding to the first sensing signal interacting with the object 415 at time Δ₁₂ after the first arrival tap (e.g., at time t₀). Additional details regarding this feature are described below in connection with FIG. 6.

As shown in connection with reference number 510, the responder network node 410 may transmit, and the initiator network node 405 may receive, a second sensing signal for sensing an object using the UWB sensing.

In some aspects, the second sensing signal may be transmitted as a reply signal. For example, the responder network node 410 may transmit the second sensing signal at a time T_{reply} after the first arrival tap (e.g., at time t₀+T_{reply}).

In some aspects, the initiator network node 405 may receive the second sensing signal and may estimate a CIR for the second sensing signal. For example, the initiator network node 405 may estimate the path loss, the delay spread, or the AoA associated with the second sensing signal.

In some aspects, the initiator network node 405 may estimate a first arrival path T_{round} relative to when the initiator network node 405 transmitted the first sensing signal. For example, T_{round} may correspond to a time between the initiator network node 405 transmitting the first sensing signal and the initiator network node 405 receiving the second sensing signal.

In some aspects, the initiator network node 405 may compute a direct path propagation (e.g., a time of flight for the direct path) based at least in part on T_{round} and T_{reply}. For example, the initiator network node 405 may compute the direct path (DP) propagation T_{prop_DP} as follows:

$${T}_{prop \_ DP} = \frac{1}{2} ( {T}_{round} - {T}_{reply} ) .$$

In some aspects, the initiator network node 405 may detect another tap corresponding to the object 415 being sensed at time Δ₂₁⁽ⁱ⁾ after the first arrival tap. In some aspects, Δ₂₁⁽ⁱ⁾ may correspond to the difference between time t₀ and the time at which the second sensing signal interacts with the object 415. For example, Δ₂₁ ⁽ⁱ⁾ may correspond to the difference between the time to and the time at which the second sensing signal interacts with the object 415 at an occurrence (i).

In some aspects, the initiator network node may estimate the time of flight corresponding to the object (T_{prop_obj}⁽ⁱ⁾) as follows:

$${T}_{prop \_ obj}^{( i )} = {T}_{prop \_ DP} + \frac{{Δ}_{12}^{( i )} + {Δ}_{21}^{( i )}}{2}$$

In some aspects, the channel may be reciprocal, and the taps may fall on the CIR sampling grid Δ₂₁ ⁽ⁱ⁾=Δ₁₂⁽ⁱ⁾ for the object 415 (e.g., except for some estimation error due to noise and clock drift between the initiator network node 405 and the responder network node 410). However, in some cases, due to a limited CIR sampling rate, the detected taps may not fall on the sampling grid points. For example, in UWB, the CIR sampling rate may be at the chip rate (e.g., 499.2 MHz) or multiples of the chip rate (e.g., 2×, 4×, or 8× the chip rate).

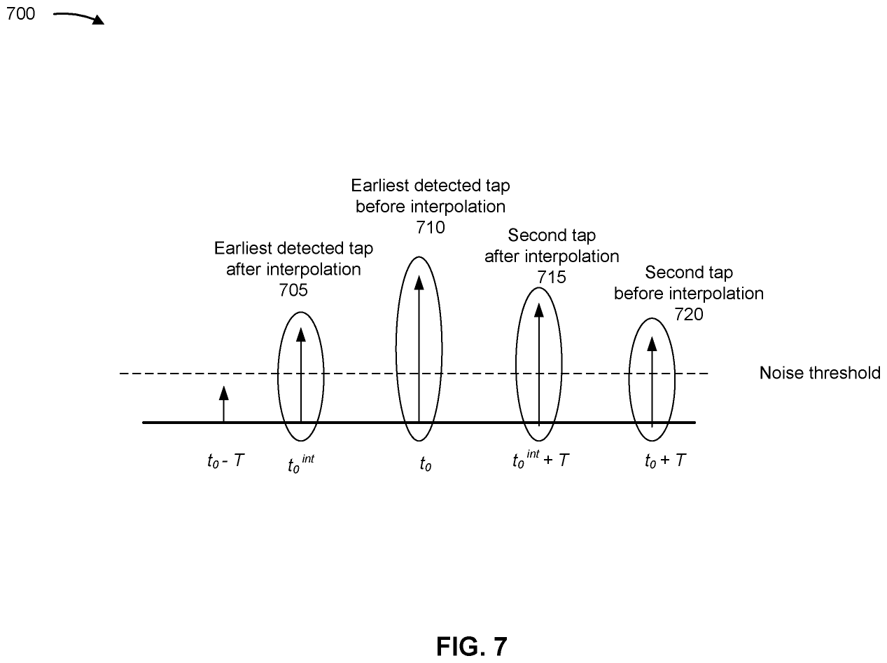

In some aspects, to achieve an accurate estimation of the object location, interpolation and/or alignment may be needed. In some cases, the interpolation may provide CIR tap values in between time domain sample grid points for the purpose of accurate estimation of object's time of arrival. In a first interpolation approach, the CIR may be interpolated at the initiator network node 405 and at the responder network node 410 prior to reporting. Additional details regarding the first interpolation approach are described in connection with FIG. 6. In a second interpolation approach, the CIR may be reported before interpolation, and the initiator network node 405 may perform the interpolation and alignment during a post-processing. Additional details regarding the second interpolation approach are described in connection with FIG. 7.

As shown in connection with reference number 515, the initiator network node 405 may obtain a location of the object 415. For example, the initiator network node 405 may determine the location of the object 415 relative to the initiator network node 405 and the responder network node 410 based at least in part on the first sensing signal and the second sensing signal

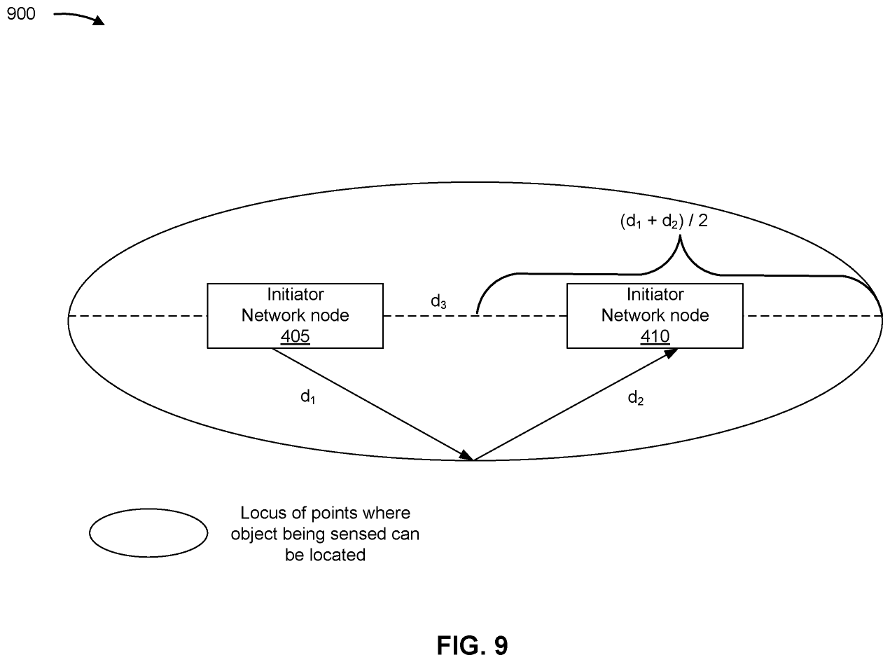

In some aspects, the initiator network node 405 may determine a locus of all of the possible locations for the object 415 based at least in part on the T_{prop_obj}. In some aspects, the initiator network node 405 may determine a first distance d1 corresponding to a distance between the initiator network node 405 and the object 415, and a second distance d2 corresponding to a distance between the responder network node 410 and the object 415. In some aspects, the distances d1 and d2 may be based at least in part on multiplying the T_{prop_obj} by a constant. For example, the constant may be the speed of light c (e.g., the speed of light in a vacuum (299,792,458 m/s)). In this example, the distances may be calculated as d1+d2=c*T_{prop_obj}. Additional details regarding these features are described in connection with FIG. 9.

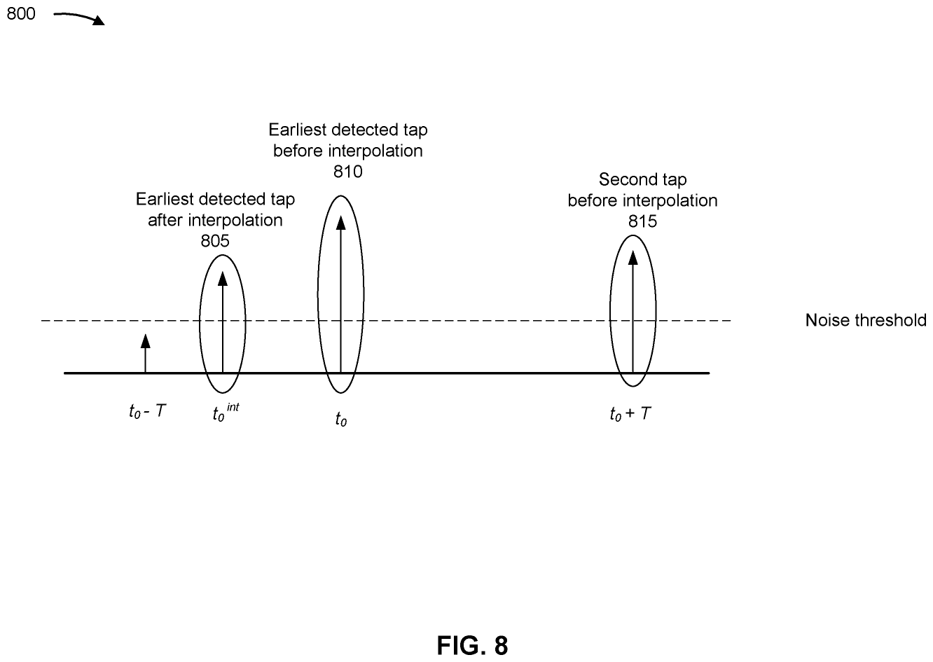

In some aspects, if the initiator network node 405 and the responder network node 410 filters are different, then the channel may not be reciprocal. In this case, there may be a mismatch between the CIR measurement corresponding to the first sensing signal interacting with the object 415 and the CIR measurement corresponding to the second sensing signal interacting with the object 415. For example, as described below in connection with FIGS. 7 and 8, h₁₂≠h₂₁. In other words, h₂₁=h₁₂*h_{mismatch}.

As described above, in some cases, the object location may be determined based at least in part on the first distance d1 and the second distance d2. However, in some cases, one or more additional measurements may be needed to resolve an ambiguity of the location of the object 415. For example, additional measurements may be needed to determine the location of the object 415 with respect to the locus.

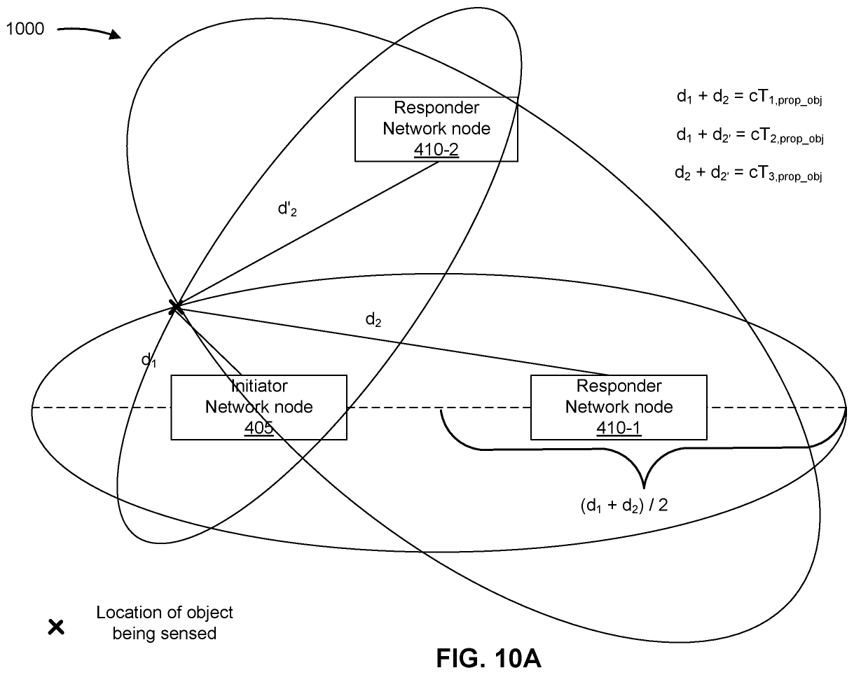

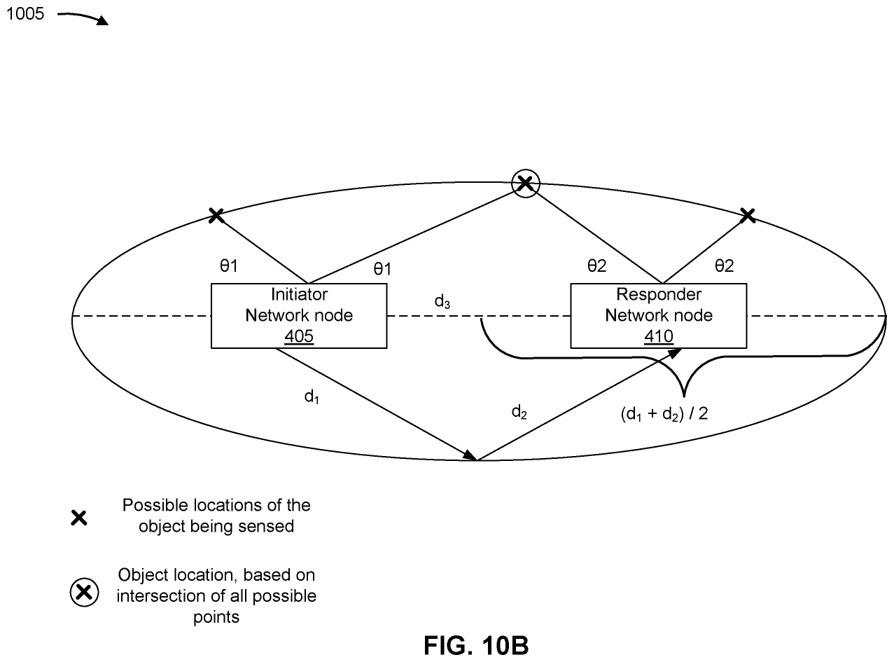

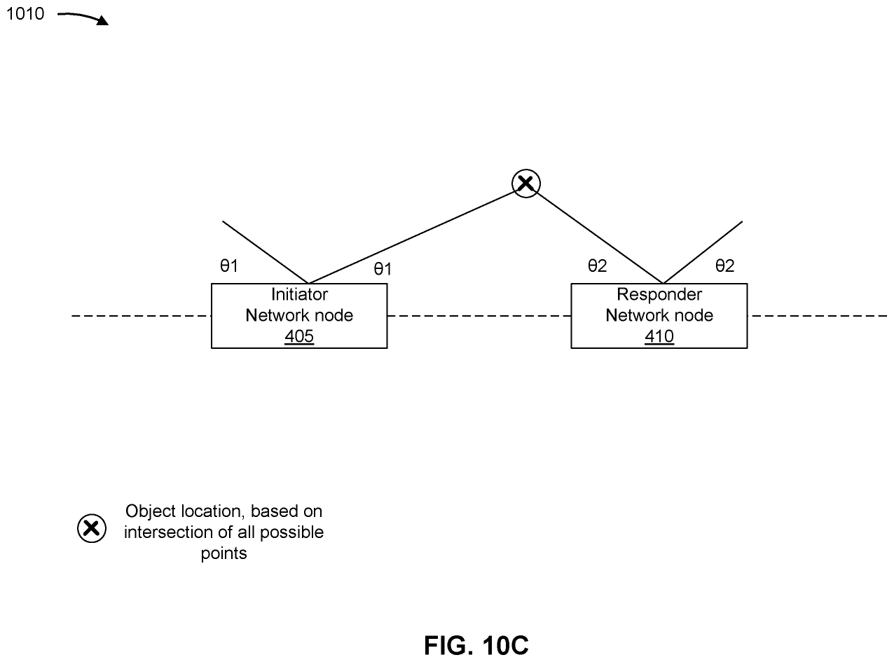

In some aspects, the initiator network node 405 may determine the location of the object 415 based at least in part on three distance measurements. Additional details regarding this feature are described in connection with FIG. 10A.

In some aspects, the initiator network node 405 may determine the location of the object 415 based at least in part on a distance measurement and one or more AoA measurements. Additional details regarding this feature are described in connection with FIG. 10B.

In some aspects, the initiator network node 405 may determine the location of the object 415 based at least in part on a plurality of AoA measurements. Additional details regarding this feature are described in connection with FIG. 10C.

While the disclosure above relates to object sensing, or sensing a location of an object, it is understood that the signaling may be used for multi-object sensing, or sensing the location of multiple objects.

As indicated above, FIG. 5 is provided as an example. Other examples may differ from what is described with regard to FIG. 5.

FIG. 6 is a diagram illustrating an example 600 of arrival paths for two-way UWB sensing, in accordance with the present disclosure. As described herein (e.g., in connection with FIG. 5), the responder network node 410 may detect a first arrival path based at least in part on the first sensing signal. The responder network node 410 may detect another arrival path based at least in part on the first sensing signal interacting with the object 415. For example, the responder network node 410 may detect another arrival path corresponding to the first sensing signal interacting with the object 415 at time Δ₁₂ after the first arrival tap. For example, as shown in the example 600, the responder network node 410 may detect a first path at the time t₀ (e.g., the earliest detected tap 605), and may detect the second path at the time t₀+Δ₁₂ (e.g., the tap corresponding to the object being sensed 610). In some aspects, the earliest detected tap 605 may be the earliest detected tap that is above the noise threshold.

As indicated above, FIG. 6 is provided as an example. Other examples may differ from what is described with regard to FIG. 6.

FIG. 7 is a diagram illustrating an example 700 of a first approach for interpolation, in accordance with the present disclosure. As described above, to achieve an accurate estimation of the object location, interpolation and alignment may be needed. In the first interpolation approach, the CIR may be interpolated at the initiator network node 405 and at the responder network node 410 prior to reporting.

In some aspects, the initiator network node 405 may transmit, and the responder network node 410 may receive, the first sensing signal (S1).

In some aspects, the responder network node 410 may estimate the CIR (h₁₂) based at least in part on the received first sensing signal. In some aspects, h₁₂ may correspond to the first sensing signal interacting with the object 415. In some aspects, h₁₂ may be estimated based at least in part on a reference point or a reference window. The reference point may be the earliest detected tap before interpolation 710.

In some aspects, the responder network node 410 may detect the first arrival path of the first sensing signal at t₀^{int} with improved (e.g., proper) accuracy via interpolating the h₁₂ around t₀ from the CIR estimate h₁₂ (e.g., by interpolating around the earliest detected tap). The earliest detected tap after interpolation may be the earliest detected tap after interpolation 705.

In some aspects, the responder network node 410 may transmit the second sensing signal (S2) at T_{reply} after the first arrival tap (e.g., at time t₀^{int}+T_{reply}).

In some aspects, the responder network node 410 may interpolate the CIR h₁₂ to obtain the CIR at sampling points relative to the earliest detected tap after interpolation h₁₂^{int}.

In some aspects, the responder network node 410 may transmit h₁₂^{int} at the interpolated points in an over-the-air (OTA) CIR measurement report.

In some aspects, the initiator network node 405 may estimate h₂₁ based at least in part on receiving the signal S2. In some aspects, h₂₁ may correspond to the sensing signal interacting with the object 415.

In some aspects, the initiator network node 405 may interpolate h₂₁ to obtain h₂₁^{int}, and may estimate the first arrival path of S2 as T_{round} relative to when the initiator network node 405 transmitted the first sensing signal.

In some aspects, the initiator network node 405 may compute the direct path propagation the time of flight as

$${T}_{prop \_ DP} = \frac{1}{2} ( {T}_{round} - {T}_{reply} ) .$$

In some aspects, the initiator network node 405 may further interpolate and align h₁₂^{int} and h₂^{int}. For example, the initiator network node 405 may interpolate from the second tap before interpolation 720 to the second tap after interpolation 715.

In some aspects, the initiator network node 405 may form a combined response as h_{comb}^{int}=|h₁₂^{int}|+|h₂₁^{int}|.

In some aspects, the initiator network node 405 may generate, based at least in part on h_{comb}^{int}, the (i)-th tap above noise threshold Δ_{comb}⁽ⁱ⁾.

In some aspects, the initiator network node 405 may estimate the propagation time for the object (T_{prop_obj}⁽ⁱ⁾) as T_{prop_obj}⁽ⁱ⁾=T_{prop_DP}+Δ_{comb}⁽ⁱ⁾.

In some aspects, the first interpolation approach may require the responder network node 410 to do the interpolation in the window immediately before reporting. This may require extra processing resources of the responder network node 410.

In some cases, the interpolation may be implementation dependent. For example, it may be possible that the initiator network node 405 and the responder network node 410 use different interpolation methods. Thus, upper layer processing may be required for further interpolation and alignment of the CIR measurements.

As indicated above, FIG. 7 is provided as an example. Other examples may differ from what is described with regard to FIG. 7.

FIG. 8 is a diagram illustrating an example 800 of a second approach for interpolation, in accordance with the present disclosure. As described above, to achieve an accurate estimation of the object location, interpolation and alignment may be needed. In the second interpolation approach, the CIR may be reported before interpolation, and the initiator network node 405 may perform the interpolation and alignment during a post-processing.

In some aspects, the initiator network node 405 may transmit, and the responder network node 410 may receive, the first sensing signal (S1).

In some aspects, the responder network node 410 may estimate the CIR (h₁₂) based at least in part on the received first sensing signal. In some aspects, h₁₂ may be estimated based at least in part on a reference point or a reference window.

In some aspects, the responder network node 410 may detect the first arrival path t₀^{int} with improved (e.g., proper) accuracy via interpolating the h₁₂ around t₀ from the CIR estimate h₁₂ (e.g., by interpolating around the earliest detected tap).

In some aspects, the responder network node 410 may transmit the second sensing signal (S2) at T_{reply} after the first arrival tap t₀^{int}+T_{reply}. In this case, the responder network node 410 may not do any further interpolation for the CIR h₁₂.

In some aspects, the responder network node 410 may transmit the raw CIR at the un-interpolated points in OTA CIR measurement report as h₁₂, such as at the earliest detected tap before interpolation 810 and the second tap before interpolation 815.

In some aspects, the responder network node 410 may transmit the offset between the first arrival path in the report and the interpolated first arrival path Δt₀=t₀−t₀^{int}.

In some aspects, the responder network node 410 may estimate h₂₁ based at least in part on receiving S2. As described above, h₂₁ may correspond to a time at which the second sensing signal interacts with the object 415.

In some aspects, the initiator network node 405 may interpolate h₂₁ to obtain h₂₁^{int}, and may estimate the first arrival path as T_{round} relative to when the initiator network node 405 transmitted the first sensing signal.

In some aspects, the initiator network node 405 may compute the direct path propagation (e.g., the time of flight) as

$${T}_{prop \_ DP} = \frac{1}{2} ( {T}_{round} - {T}_{reply} ) .$$

In some aspects, the initiator network node 405 (e.g., an upper layer of the initiator network node 405) may interpolate h₁₂ to produce h₁₂^{int}.

In some aspects, the initiator network node 405 may further interpolate and align h₁₂^{int} and h₁₂^{int}. This may be implementation specific.

In some aspects, the initiator network node 405 may form the combined response as h_{comb}^{int}=|h₁₂^{int}|+|h₂₁^{int}|.

In some aspects, the initiator network node 405 may generate, based at least in part on h_{comb}^{int}, the (i)-th tap above noise threshold Δ_{comb}⁽ⁱ⁾.

In some aspects, the initiator network node 405 may estimate the propagation time for the object (T_{prop_obj}⁽ⁱ⁾) as T_{prop_obj}⁽ⁱ⁾=T_{prop_DP}+Δ_{comb}⁽ⁱ⁾.

In some aspects, the responder network node 410 may report the offset Δt₀=t₀−t₀^{int} in order to assist with alignment. For example, the initiator network node 405 may interpolate and further align the CIR h₁₂^{int} and h₂₁^{int} based on the offset.

As indicated above, FIG. 8 is provided as an example. Other examples may differ from what is described with regard to FIG. 8.

FIG. 9 is a diagram illustrating an example 900 of a locus for an object location, in accordance with the present disclosure.

As described above (e.g., in connection with FIG. 5), the initiator network node 405 may determine a locus of all of the possible locations for the object 415 based at least in part on the T_{prop_obj}. In some aspects, the initiator network node 405 may determine a first distance d1 corresponding to a distance between the initiator network node 405 and a possible location of the object 415, and a second distance d2 corresponding to a distance between the responder network node 410 and a possible location of the object 415. In some aspects, the distances d1 and d2 may be based at least in part on multiplying the T_{prop_obj} by a constant. For example, the constant may be the speed of light c. In this example, the distances may be calculated as d1+d2=c*T_{prop_obj}.

In some aspects, as shown in connection with the example 900, the initiator network node 405 may determine the locus that corresponds to all of the points where the object 415 can be located. The locus may be based at least in part on the distance d1 and the distance d2. For example, the locus may be an ellipse with a semi-major axis length that is equal to one half of the sum of the distances (e.g., d=½*(d1+d2)).

As indicated above, FIG. 9 is provided as an example. Other examples may differ from what is described with regard to FIG. 9.

In some cases, as described above, the object location may be determined based at least in part on the first distance d1 and the second distance d2. However, in some cases, one or more additional measurements may be needed to resolve an ambiguity of the location of the object 415. For example, additional measurements may be needed to determine the location (e.g., resolve the location ambiguity) of the object 415 with respect to the locus.

FIGS. 10A, 10B, and 10C are diagrams illustrating examples 1000, 1005, and 1010, respectively, for resolving object location ambiguity, in accordance with the present disclosure.

As shown in connection with the example 1000 of FIG. 10A, the location of the object 415 may be determined based at least in part on three distance measurements. For example, one or more of the initiator network node 405, the responder network node 410-1, and the responder network node 410-2 may determine the location of the object 415 based at least in part on the intersection of the three ellipses. As shown in the figure, a first distance d1 may correspond to a distance between the initiator network node 405 and the object 415. A second distance d2 may correspond to a distance between the responder network node 410-1 and the object 415. A third distance d₂′ may correspond to a distance between the responder network node 410-2 and the object 415. The location of the object 415 may be determined based at least in part on the measurements d₁, d₂, and d₂′. For example, the location of the object 415 may be an ellipse with major-axis length determined based at least in part on the plurality of formulas shown below:

d₁+d₂=c*T_{1,prop_obj};

d₁+d_{2′}=c*T_{2,prop_obj}; and

d₂+d_{2′}=c*T_{3,prop_obj}.

As shown in connection with the example 1005 of FIG. 10B, the location of the object 415 may be determined based at least in part on a distance measurement and one or more AoA measurements. For example, if there are multiple antennas at the initiator network node 405 and/or the responder network node 410, then the AoA (in addition to T_{prop_obj}) relative to the initiator network node 405 and/or relative to the responder network node 410 may be used to locate the object 415. As described above, a locus of the possible locations of the object 415 may be determined based at least in part on the distance measurements d₁ and d₂. As shown in the figure, the AoA relative to the initiator network node 405 may be θ1, and the AoA relative to the responder network node 410 may be θ2. In some cases, the antenna arrays of the initiator network node 405 may be vertically facing the antenna arrays of the responder network node 410. In this case, one of the AoAs (e.g., θ1) may provide two candidate points on the locus, and the other AoA (e.g., θ2) may resolve the location of the object 415 on the locus.

As shown in connection with the example 1010 of FIG. 10C, the location of the object 415 may be determined based at least in part on two AoA measurements. The parameters for the example 1010 may be similar to those of the example 1005. However, in the absence of two-way sensing measurements, it may still be possible to estimate the object 415 location.

As indicated above, FIGS. 10A, 10B, and 10C are provided as examples. Other examples may differ from what is described with regard to FIGS. 10A, 10B, and 10C.

FIG. 11 is a diagram illustrating an example process 1100 performed, for example, by an initiator network node, in accordance with the present disclosure. Example process 1100 is an example where the initiator network node (e.g., initiator network node 405) performs operations associated with two-way ultra-wideband sensing.

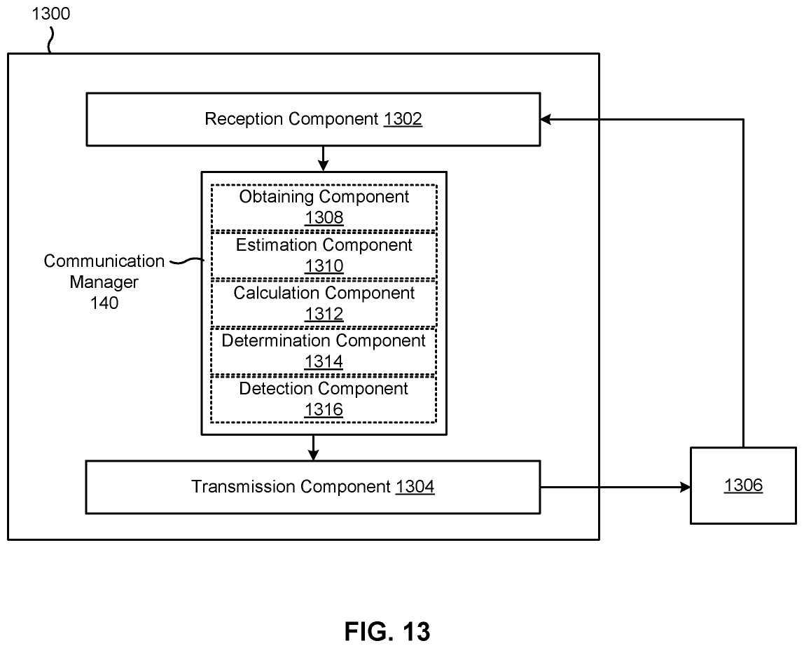

As shown in FIG. 11, in some aspects, process 1100 may include transmitting a first sensing signal for sensing an object using ultra-wideband sensing (block 1110). For example, the initiator network node (e.g., using communication manager 140 and/or transmission component 1304, depicted in FIG. 13) may transmit a first sensing signal for sensing an object using ultra-wideband sensing, as described above.

As further shown in FIG. 11, in some aspects, process 1100 may include receiving, from a responder network node, a second sensing signal, that is based at least in part on the first sensing signal, for sensing the object using the ultra-wideband sensing (block 1120). For example, the initiator network node (e.g., using communication manager 140 and/or reception component 1302, depicted in FIG. 13) may receive, from a responder network node, a second sensing signal, that is based at least in part on the first sensing signal, for sensing the object using the ultra-wideband sensing, as described above.

As further shown in FIG. 11, in some aspects, process 1100 may include obtaining a location of the object relative to the initiator network node and the responder network node based at least in part on the first sensing signal and the second sensing signal (block 1130). For example, the initiator network node (e.g., using communication manager 140 and/or obtaining component 1308, depicted in FIG. 13) may obtain a location of the object relative to the initiator network node and the responder network node based at least in part on the first sensing signal and the second sensing signal, as described above.

Process 1100 may include additional aspects, such as any single aspect or any combination of aspects described below and/or in connection with one or more other processes described elsewhere herein.

In a first aspect, the initiator network node and the responder network node are configured for bi-static two-way sensing, or part of multi-static two-way sensing.

In a second aspect, alone or in combination with the first aspect, process 1100 includes estimating a channel impulse response based at least in part on receiving the second sensing signal.

In a third aspect, alone or in combination with one or more of the first and second aspects, process 1100 includes calculating a round trip time based at least in part on a transmission time that corresponds to a time at which the first sensing signal was transmitted and a reception time that corresponds to a time at which the second sensing signal was received.

In a fourth aspect, alone or in combination with one or more of the first through third aspects, process 1100 includes calculating a direct path time based at least in part on the round trip time and a reply time offset that corresponds to a time interval between receiving the first sensing packet and a time at which the second sensing signal was transmitted by the responder network node.

In a fifth aspect, alone or in combination with one or more of the first through fourth aspects, the reply time is relative to an earliest CIR detected tap, estimated from the first sensing signal, and wherein calculating the direct path time comprises calculating one half of a difference between the round trip time and the reply time.

In a sixth aspect, alone or in combination with one or more of the first through fifth aspects, process 1100 includes calculating a propagation time based at least in part on the direct path time, a first time interval associated with a propagation time of the first sensing signal interacting with the object, and a second time interval associated with the propagation time of the second sensing signal interacting with the object.

In a seventh aspect, alone or in combination with one or more of the first through sixth aspects, the first time interval is a difference between a time corresponding to an earliest detected tap and a time corresponding to the reflection of the first sensing signal interacting with the object, and the second time interval is a difference between the time corresponding to the earliest detected tap and a time corresponding to the second sensing signal interacting with the object.

In an eighth aspect, alone or in combination with one or more of the first through seventh aspects, calculating the propagation time comprises calculating a sum of the direct path time and one half of the sum of the first time interval and the second time interval.

In a ninth aspect, alone or in combination with one or more of the first through eighth aspects, process 1100 includes calculating a first distance from the initiator network node to the object and a second distance from the responder network node to the object based at least in part on multiplying the propagation time by a constant.

In a tenth aspect, alone or in combination with one or more of the first through ninth aspects, the constant is a speed of light.

In an eleventh aspect, alone or in combination with one or more of the first through tenth aspects, obtaining the location of the object comprises determining the location of the object based at least in part on the first distance or the second distance.

In a twelfth aspect, alone or in combination with one or more of the first through eleventh aspects, determining the location of the object further comprises determining the location of the object based at least in part on the first distance, the second distance, and a third distance associated with another network node.

In a thirteenth aspect, alone or in combination with one or more of the first through twelfth aspects, determining the location of the object further comprises determining the location of the object based at least in part on the first distance or the second distance, and an angle of arrival measurement.

In a fourteenth aspect, alone or in combination with one or more of the first through thirteenth aspects, determining the location of the object further comprises determining the location of the object based at least in part on a plurality of angle of arrival measurements.

In a fifteenth aspect, alone or in combination with one or more of the first through fourteenth aspects, process 1100 includes receiving, from the responder network node, a first interpolated channel impulse response associated with the first sensing signal interacting with the object, and determining, by the initiator network node, a second interpolated channel impulse response associated with the second sensing signal interacting with the object.

In a sixteenth aspect, alone or in combination with one or more of the first through fifteenth aspects, process 1100 includes calculating a round trip time based at least in part on the second interpolated channel impulse response and a transmission time that corresponds to a time at which the first sensing signal was transmitted.

In a seventeenth aspect, alone or in combination with one or more of the first through sixteenth aspects, process 1100 includes calculating a direct path time based at least in part on the round trip time and an interpolated reply time that corresponds to a time at which the second sensing signal was transmitted by the responder network node.

In an eighteenth aspect, alone or in combination with one or more of the first through seventeenth aspects, process 1100 includes calculating an interpolated combined channel impulse response based at least in part on a sum of the first interpolated channel impulse response and the second interpolated channel impulse response.

In a nineteenth aspect, alone or in combination with one or more of the first through eighteenth aspects, process 1100 includes determining a combined time interval based at least in part on the interpolated combined channel impulse response and a tap that is above a noise threshold.

In a twentieth aspect, alone or in combination with one or more of the first through nineteenth aspects, process 1100 includes calculating a propagation time based at least in part on the direct path time and the combined time interval.

In a twenty-first aspect, alone or in combination with one or more of the first through twentieth aspects, process 1100 includes determining, by the initiator network node, a first interpolated channel impulse response associated with the first sensing signal interacting with the object, and determining, by the initiator network node, a second interpolated channel impulse response associated with the second sensing signal interacting with the object.

In a twenty-second aspect, alone or in combination with one or more of the first through twenty-first aspects, process 1100 includes calculating a round trip time based at least in part on the second interpolated channel impulse response and a transmission time that corresponds to a time at which the first sensing signal was transmitted.

In a twenty-third aspect, alone or in combination with one or more of the first through twenty-second aspects, process 1100 includes calculating a direct path time based at least in part on the round trip time and an interpolated reply time that corresponds to a time at which the second sensing signal was transmitted by the responder network node.

In a twenty-fourth aspect, alone or in combination with one or more of the first through twenty-third aspects, process 1100 includes calculating an interpolated combined channel impulse response based at least in part on a sum of the first interpolated channel impulse response and the second interpolated channel impulse response.

In a twenty-fifth aspect, alone or in combination with one or more of the first through twenty-fourth aspects, process 1100 includes determining a combined time interval based at least in part on the interpolated combined channel impulse response and a tap that is above a noise threshold.

In a twenty-sixth aspect, alone or in combination with one or more of the first through twenty-fifth aspects, process 1100 includes calculating a propagation time based at least in part on the direct path time and the combined time interval.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

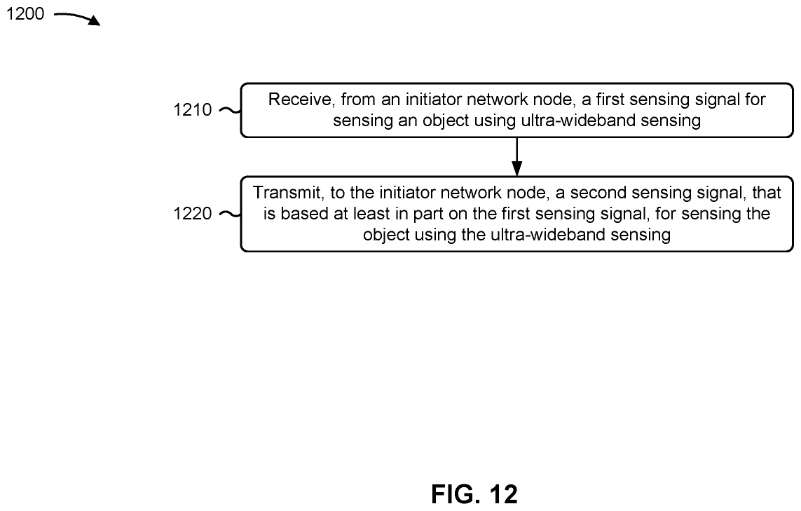

FIG. 12 is a diagram illustrating an example process 1200 performed, for example, by a responder network node, in accordance with the present disclosure. Example process 1200 is an example where the responder network node (e.g., responder network node 410) performs operations associated with two-way ultra-wideband sensing.

As shown in FIG. 12, in some aspects, process 1200 may include receiving, from an initiator network node, a first sensing signal for sensing an object using ultra-wideband sensing (block 1210). For example, the responder network node (e.g., using communication manager 140 and/or reception component 1302, depicted in FIG. 13) may receive, from an initiator network node, a first sensing signal for sensing an object using ultra-wideband sensing, as described above.

As further shown in FIG. 12, in some aspects, process 1200 may include transmitting, to the initiator network node, a second sensing signal, that is based at least in part on the first sensing signal, for sensing the object using the ultra-wideband sensing (block 1220). For example, the responder network node (e.g., using communication manager 140 and/or transmission component 1304, depicted in FIG. 13) may transmit, to the initiator network node, a second sensing signal, that is based at least in part on the first sensing signal, for sensing the object using the ultra-wideband sensing, as described above.

Process 1200 may include additional aspects, such as any single aspect or any combination of aspects described below and/or in connection with one or more other processes described elsewhere herein.

In a first aspect, process 1200 includes estimating a channel impulse response based at least in part on the first sensing signal

In a second aspect, alone or in combination with the first aspect, process 1200 includes detecting a first arrival path based at least in part on the channel impulse response.

In a third aspect, alone or in combination with one or more of the first and second aspects, process 1200 includes detecting a second arrival path based at least in part on the first sensing signal interacting with the object.

In a fourth aspect, alone or in combination with one or more of the first through third aspects, transmitting the second sensing signal comprises transmitting the second sensing signal after an arrival tap corresponding to the second arrival path.

In a fifth aspect, alone or in combination with one or more of the first through fourth aspects, process 1200 includes estimating a first interpolated channel impulse response from the first sensing signal based at least in part on a first arrival tap that corresponds to an earliest detected arrival tap.

In a sixth aspect, alone or in combination with one or more of the first through fifth aspects, process 1200 includes transmitting the second sensing signal at a second arrival tap that is after the first arrival tap.

In a seventh aspect, alone or in combination with one or more of the first through sixth aspects, process 1200 includes estimating a second interpolated channel impulse response based at least in part on transmitting the second sensing signal at the second arrival tap.

In an eighth aspect, alone or in combination with one or more of the first through seventh aspects, process 1200 includes transmitting, to the initiator network node, an indication of the second interpolated channel impulse response.

In a ninth aspect, alone or in combination with one or more of the first through eighth aspects, process 1200 includes transmitting, to the initiator network node, an indication of a second channel impulse response based at least in part on transmitting the second sensing signal at the second arrival tap.

In a tenth aspect, alone or in combination with one or more of the first through ninth aspects, the second channel impulse response is a non-interpolated channel impulse response.

In an eleventh aspect, alone or in combination with one or more of the first through tenth aspects, process 1200 includes transmitting an indication of an offset between the first arrival tap and the second arrival tap.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a network node, or a network node may include the apparatus 1300. The network node may be an initiator network node, such as the initiator network node 405, a responder network node, such as the responder network node 410, or a combination of the initiator network node and the responder network node. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of an obtaining component 1308, an estimation component 1310, a calculation component 1312, a determination component 1314, or a detection component 1316, among other examples.

In some aspects, the apparatus 1300 may be configured to perform one or more operations described herein in connection with FIGS. 5-10. Additionally, or alternatively, the apparatus 1300 may be configured to perform one or more processes described herein, such as process 1100 of FIG. 11, process 1200 of FIG. 12, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit a first sensing signal for sensing an object using ultra-wideband sensing. The reception component 1302 may receive, from a responder network node, a second sensing signal, that is based at least in part on the first sensing signal, for sensing the object using the ultra-wideband sensing. The obtaining component 1308 may obtain a location of the object relative to the initiator network node and the responder network node based at least in part on the first sensing signal and the second sensing signal

The estimation component 1310 may estimate a channel impulse response based at least in part on receiving the second sensing signal.

The calculation component 1312 may calculate a round trip time based at least in part on a transmission time that corresponds to a time at which the first sensing signal was transmitted and a reception time that corresponds to a time at which the second sensing signal was received.

The calculation component 1312 may calculate a direct path time based at least in part on the round trip time and a reply time offset that corresponds to a time interval between receiving the first sensing packet and a time at which the second sensing signal was transmitted by the responder network node.

The calculation component 1312 may calculate a propagation time based at least in part on the direct path time, a first time interval associated with a reflection of the first sensing signal interacting with the object, and a second time interval associated with the reflection of the second sensing signal interacting with the object.

The calculation component 1312 may calculate a first distance from the initiator network node to the object and a second distance from the responder network node to the object based at least in part on multiplying the propagation time by a constant.

The reception component 1302 may receive, from the responder network node, a first interpolated channel impulse response associated with the first sensing signal interacting with the object.

The determination component 1314 may determine a second interpolated channel impulse response associated with the second sensing signal interacting with the object.

The calculation component 1312 may calculate a round trip time based at least in part on the second interpolated channel impulse response and a transmission time that corresponds to a time at which the first sensing signal was transmitted.

The calculation component 1312 may calculate a direct path time based at least in part on the round trip time and an interpolated reply time that corresponds to a time at which the second sensing signal was transmitted by the responder network node.

The calculation component 1312 may calculate an interpolated combined channel impulse response based at least in part on a sum of the first interpolated channel impulse response and the second interpolated channel impulse response.

The determination component 1314 may determine a combined time interval based at least in part on the interpolated combined channel impulse response and a tap that is above a noise threshold.

The calculation component 1312 may calculate a propagation time based at least in part on the direct path time and the combined time interval.

The determination component 1314 may determine a first interpolated channel impulse response associated with the first sensing signal interacting with the object.

The determination component 1314 may determine a second interpolated channel impulse response associated with the second sensing signal interacting with the object.

The calculation component 1312 may calculate a round trip time based at least in part on the second interpolated channel impulse response and a transmission time that corresponds to a time at which the first sensing signal was transmitted.

The calculation component 1312 may calculate a direct path time based at least in part on the round trip time and an interpolated reply time that corresponds to a time at which the second sensing signal was transmitted by the responder network node.

The calculation component 1312 may calculate an interpolated combined channel impulse response based at least in part on a sum of the first interpolated channel impulse response and the second interpolated channel impulse response.

The determination component 1314 may determine a combined time interval based at least in part on the interpolated combined channel impulse response and a tap that is above a noise threshold.

The calculation component 1312 may calculate a propagation time based at least in part on the direct path time and the combined time interval.

The reception component 1302 may receive, from an initiator network node, a first sensing signal for sensing an object using ultra-wideband sensing. The transmission component 1304 may transmit, to the initiator network node, a second sensing signal, that is based at least in part on the first sensing signal, for sensing the object using the ultra-wideband sensing.

The estimation component 1310 may estimate a channel impulse response based at least in part on the first sensing signal.

The detection component 1316 may detect a first arrival path based at least in part on the channel impulse response.

The detection component 1316 may detect a second arrival path based at least in part on the first sensing signal interacting with the object.

The estimation component 1310 may estimate a first interpolated channel impulse response from the first sensing signal based at least in part on a first arrival tap that corresponds to an earliest detected arrival tap.

The transmission component 1304 may transmit the second sensing signal at a second arrival tap that is after the first arrival tap.

The estimation component 1310 may estimate a second interpolated channel impulse response based at least in part on transmitting the second sensing signal at the second arrival tap.

The transmission component 1304 may transmit, to the initiator network node, an indication of the second interpolated channel impulse response.

The transmission component 1304 may transmit, to the initiator network node, an indication of a second channel impulse response based at least in part on transmitting the second sensing signal at the second arrival tap.

The transmission component 1304 may transmit an indication of an offset between the first arrival tap and the second arrival tap.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by an initiator network node, comprising: transmitting a first sensing signal for sensing an object using ultra-wideband sensing; receiving, from a responder network node, a second sensing signal, that is based at least in part on the first sensing signal, for sensing the object using the ultra-wideband sensing; and obtaining a location of the object relative to the initiator network node and the responder network node based at least in part on the first sensing signal and the second sensing signal.

Aspect 2: The method of Aspect 1, wherein the initiator network node and the responder network node are configured for bi-static two-way sensing.

Aspect 3: The method of any of Aspects 1-2, further comprising estimating a channel impulse response based at least in part on receiving the second sensing signal.

Aspect 4: The method of any of Aspects 1-3, further comprising calculating a round trip time based at least in part on a transmission time that corresponds to a time at which the first sensing signal was transmitted and a reception time that corresponds to a time at which the second sensing signal was received.

Aspect 5: The method of Aspect 4, further comprising calculating a direct propagation path time based at least in part on the round trip time and a reply time offset that corresponds to a time interval between receiving the first sensing packet and a time at which the second sensing signal was transmitted by the responder network node.

Aspect 6: The method of Aspect 5, wherein the reply time is relative to an earliest detected tap, and wherein calculating the direct path time comprises calculating one half of a difference between the round trip time and the reply time.

Aspect 7: The method of Aspect 6, further comprising calculating a propagation time based at least in part on the direct path time, a first time interval associated with a reflection of the first sensing signal interacting with the object, and a second time interval associated with the reflection of the second sensing signal interacting with the object.

Aspect 8: The method of Aspect 7, wherein the first time interval is a difference between a time corresponding to an earliest detected tap and a time corresponding to the reflection of the first sensing signal interacting with the object, and the second time interval is a difference between the time corresponding to the earliest detected tap and a time corresponding to the second sensing signal interacting with the object.

Aspect 9: The method of Aspect 7, wherein calculating the propagation time comprises calculating a sum of the direct path time and one half of the sum of the first time interval and the second time interval.

Aspect 10: The method of Aspect 7, further comprising calculating a summation of a first distance from the initiator network node to the object and a second distance from the responder network node to the object based at least in part on multiplying the propagation time by a constant.

Aspect 11: The method of Aspect 10, wherein the constant is a speed of light.

Aspect 12: The method of Aspect 10, wherein obtaining the location of the object comprises determining a locus of possible locations of the object based at least in part on the summation of first distance and the second distance.

Aspect 13: The method of Aspect 12, wherein determining the location of the object further comprises determining the location of the object based at least in part on the first distance, the second distance, and a third distance associated with another network node.

Aspect 14: The method of Aspect 12, wherein determining the location of the object further comprises determining the location of the object based at least in part on the summation of the first distance and the second distance, and an angle of arrival measurement.

Aspect 15: The method of Aspect 12, wherein determining the location of the object further comprises determining the location of the object based at least in part on a plurality of angle of arrival measurements.

Aspect 16: The method of any of Aspects 1-15, further comprising: receiving, from the responder network node, a first interpolated channel impulse response associated with the first sensing signal interacting with the object; and determining, by the initiator network node, a second interpolated channel impulse response associated with the second sensing signal interacting with the object.

Aspect 17: The method of Aspect 16, further comprising calculating a round trip time based at least in part on the second interpolated channel impulse response and a transmission time that corresponds to a time at which the first sensing signal was transmitted.

Aspect 18: The method of Aspect 17, further comprising calculating a direct path time based at least in part on the round trip time and an interpolated reply time that corresponds to a time at which the second sensing signal was transmitted by the responder network node.

Aspect 19: The method of Aspect 18, further comprising calculating an interpolated combined channel impulse response based at least in part on a sum of the first interpolated channel impulse response and the second interpolated channel impulse response.

Aspect 20: The method of Aspect 19, further comprising determining a combined time interval based at least in part on the interpolated combined channel impulse response and a tap that is above a noise threshold.

Aspect 21: The method of Aspect 20, further comprising calculating a propagation time based at least in part on the direct path time and the combined time interval.

Aspect 22: The method of any of Aspects 1-21, further comprising: determining, by the initiator network node, a first interpolated channel impulse response associated with the first sensing signal interacting with the object; and determining, by the initiator network node, a second interpolated channel impulse response associated with the second sensing signal interacting with the object.

Aspect 23: The method of Aspect 22, further comprising calculating a round trip time based at least in part on the second interpolated channel impulse response and a transmission time that corresponds to a time at which the first sensing signal was transmitted.

Aspect 24: The method of Aspect 23, further comprising calculating a direct path time based at least in part on the round trip time and an interpolated reply time that corresponds to a time at which the second sensing signal was transmitted by the responder network node.

Aspect 25: The method of Aspect 24, further comprising calculating an interpolated combined channel impulse response based at least in part on a sum of the first interpolated channel impulse response and the second interpolated channel impulse response.

Aspect 26: The method of Aspect 25, further comprising determining a combined time interval based at least in part on the interpolated combined channel impulse response and a tap that is above a noise threshold.

Aspect 27: The method of Aspect 26, further comprising calculating a propagation time based at least in part on the direct path time and the combined time interval.

Aspect 28: A method of wireless communication performed by a responder network node, comprising: receiving, from an initiator network node, a first sensing signal for sensing an object using ultra-wideband sensing; and transmitting, to the initiator network node, a second sensing signal, that is based at least in part on the first sensing signal, for sensing the object using the ultra-wideband sensing.

Aspect 29: The method of Aspect 28, further comprising estimating a channel impulse response based at least in part on the first sensing signal.

Aspect 30: The method of Aspect 29, further comprising detecting a first arrival path based at least in part on the channel impulse response.

Aspect 31: The method of Aspect 30, further comprising detecting a second arrival path based at least in part on the first sensing signal interacting with the object.

Aspect 32: The method of Aspect 31, wherein transmitting the second sensing signal comprises transmitting the second sensing signal after an arrival tap corresponding to the second arrival path.

Aspect 33: The method of any of Aspects 28-32, further comprising estimating a first interpolated channel impulse response from the first sensing signal based at least in part on a first arrival tap that corresponds to an earliest detected arrival tap.

Aspect 34: The method of Aspect 33, further comprising transmitting the second sensing signal at a second arrival tap that is after the first arrival tap.

Aspect 35: The method of Aspect 34, further comprising estimating a second interpolated channel impulse response based at least in part on transmitting the second sensing signal at the second arrival tap.

Aspect 36: The method of Aspect 35, further comprising transmitting, to the initiator network node, an indication of the second interpolated channel impulse response.

Aspect 37: The method of Aspect 34, further comprising transmitting, to the initiator network node, an indication of a second channel impulse response based at least in part on transmitting the second sensing signal at the second arrival tap.

Aspect 38: The method of Aspect 37, wherein the second channel impulse response is a non-interpolated channel impulse response.

Aspect 39: The method of Aspect 37, further comprising transmitting an indication of an offset between the first arrival tap and the second arrival tap.

Aspect 40: An apparatus for wireless communication at a device, comprising a processor; memory coupled with the processor; and instructions stored in the memory and executable by the processor to cause the apparatus to perform the method of one or more of Aspects 1-27.

Aspect 41: A device for wireless communication, comprising a memory and one or more processors coupled to the memory, the one or more processors configured to perform the method of one or more of Aspects 1-27.

Aspect 42: An apparatus for wireless communication, comprising at least one means for performing the method of one or more of Aspects 1-27.

Aspect 43: A non-transitory computer-readable medium storing code for wireless communication, the code comprising instructions executable by a processor to perform the method of one or more of Aspects 1-27.

Aspect 44: A non-transitory computer-readable medium storing a set of instructions for wireless communication, the set of instructions comprising one or more instructions that, when executed by one or more processors of a device, cause the device to perform the method of one or more of Aspects 1-27.

Aspect 45: An apparatus for wireless communication at a device, comprising a processor; memory coupled with the processor; and instructions stored in the memory and executable by the processor to cause the apparatus to perform the method of one or more of Aspects 28-39.

Aspect 46: A device for wireless communication, comprising a memory and one or more processors coupled to the memory, the one or more processors configured to perform the method of one or more of Aspects 28-39.

Aspect 47: An apparatus for wireless communication, comprising at least one means for performing the method of one or more of Aspects 28-39.

Aspect 48: A non-transitory computer-readable medium storing code for wireless communication, the code comprising instructions executable by a processor to perform the method of one or more of Aspects 28-39.

Aspect 49: A non-transitory computer-readable medium storing a set of instructions for wireless communication, the set of instructions comprising one or more instructions that, when executed by one or more processors of a device, cause the device to perform the method of one or more of Aspects 28-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c +c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at an initiator network node, comprising:
a memory; and
one or more processors, coupled to the memory, configured to:
transmit a first sensing signal for sensing an object using ultra-wideband sensing;
receive, from a responder network node, a second sensing signal, that is based at least in part on the first sensing signal, for sensing the object using the ultra-wideband sensing; and
obtain a location of the object relative to the initiator network node and the responder network node based at least in part on the first sensing signal and the second sensing signal.

2. The apparatus of claim 1, wherein the one or more processors are further configured to:
estimate a channel impulse response based at least in part on receiving the second sensing signal; and
calculate a round trip time based at least in part on a transmission time that corresponds to a time at which the first sensing signal was transmitted and a reception time that corresponds to a time at which the second sensing signal was received.

3. The apparatus of claim 2, wherein the one or more processors are further configured to calculate a direct propagation path time based at least in part on the round trip time and a reply time offset that corresponds to a time interval between receiving the first sensing signal and a time at which the second sensing signal was transmitted by the responder network node.

4. The apparatus of claim 3, wherein the reply time is relative to an earliest detected tap, and wherein calculating the direct propagation path time comprises calculating one half of a difference between the round trip time and the reply time.

5. The apparatus of claim 3, wherein the one or more processors are further configured to calculate a propagation time based at least in part on the direct propagation path time, a first time interval associated with a propagation time of the first sensing signal interacting with the object, and a second time interval associated with the propagation time of the second sensing signal interacting with the object, wherein the first time interval is a difference between a time corresponding to an earliest detected tap and a time corresponding to the propagation time of the first sensing signal interacting with the object, and the second time interval is a difference between the time corresponding to the earliest detected tap and a time corresponding to the second sensing signal interacting with the object.

6. The apparatus of claim 5, wherein the one or more processors, to calculate the propagation time, are configured to calculate a sum of the direct propagation path time and one half of the sum of the first time interval and the second time interval.

7. The apparatus of claim 5, wherein the one or more processors are further configured to calculate summation of a first distance from the initiator network node to the object and a second distance from the responder network node to the object based at least in part on multiplying the propagation time by a constant.

8. The apparatus of claim 7, wherein the one or more processors, to obtain the location of the object, are configured to determine a locus of possible locations of the object based at least in part on the summation of first distance and the second distance.

9. The apparatus of claim 8, wherein the one or more processors, to determine the location of the object, are configured to determine the location of the object based at least in part on:
the first distance, the second distance, and a third distance associated with another network node;
a summation of the first distance and the second distance, and an angle of arrival measurement; or
a plurality of angle of arrival measurements.

10. The apparatus of claim 1, wherein the one or more processors are further configured to:
receive, from the responder network node, a first interpolated channel impulse response associated with the first sensing signal interacting with the object, wherein the first interpolated channel impulse response is interpolated in a time domain; and
determine a second interpolated channel impulse response associated with the second sensing signal interacting with the object.

11. The apparatus of claim 10, wherein the one or more processors are further configured to calculate a round trip time based at least in part on the second interpolated channel impulse response and a transmission time that corresponds to a time at which the first sensing signal was transmitted.

12. The apparatus of claim 11, wherein the one or more processors are further configured to calculate a direct propagation path time based at least in part on the round trip time and an interpolated reply time that corresponds to a time at which the second sensing signal was transmitted by the responder network node.

13. The apparatus of claim 12, wherein the one or more processors are further configured to calculate an interpolated combined channel impulse response based at least in part on a sum of the first interpolated channel impulse response and the second interpolated channel impulse response.

14. The apparatus of claim 13, wherein the one or more processors are further configured to:
determine a combined time interval based at least in part on the interpolated combined channel impulse response and a tap that is above a noise threshold; and
calculate a propagation time based at least in part on the direct propagation path time and the combined time interval.

15. The apparatus of claim 1, wherein the one or more processors are further configured to:
determine a first interpolated channel impulse response associated with the first sensing signal interacting with the object, wherein the first interpolated channel impulse response is interpolated in a time domain; and
determine a second interpolated channel impulse response associated with the second sensing signal interacting with the object.

16. The apparatus of claim 15, wherein the one or more processors are further configured to calculate a round trip time based at least in part on the second interpolated channel impulse response and a transmission time that corresponds to a time at which the first sensing signal was transmitted.

17. The apparatus of claim 16, wherein the one or more processors are further configured to calculate a direct propagation path time based at least in part on the round trip time and an interpolated reply time that corresponds to a time at which the second sensing signal was transmitted by the responder network node.

18. The apparatus of claim 17, wherein the one or more processors are further configured to calculate an interpolated combined channel impulse response based at least in part on a sum of the first interpolated channel impulse response and the second interpolated channel impulse response.

19. The apparatus of claim 18, wherein the one or more processors are further configured to:
determine a combined propagation time interval based at least in part on the interpolated combined channel impulse response and a tap that is above a noise threshold; and
calculate a propagation time based at least in part on the direct propagation path time and the combined propagation time interval.

20. An apparatus for wireless communication at a responder network node, comprising:
a memory; and
one or more processors, coupled to the memory, configured to:
receive, from an initiator network node, a first sensing signal for sensing an object using ultra-wideband sensing; and
transmit, to the initiator network node, a second sensing signal, that is based at least in part on the first sensing signal, for sensing the object using the ultra-wideband sensing.

21. The apparatus of claim 20, wherein the one or more processors are further configured to estimate a channel impulse response based at least in part on the first sensing signal.

22. The apparatus of claim 21, wherein the one or more processors are further configured to:
detect a first arrival path based at least in part on the channel impulse response; and
detect a second arrival path based at least in part on the first sensing signal interacting with the object.

23. The apparatus of claim 22, wherein the one or more processors, to transmit the second sensing signal, are configured to transmit the second sensing signal after an arrival tap corresponding to the first arrival path estimated from the first sensing signal.

24. The apparatus of claim 20, wherein the one or more processors are further configured to estimate a first interpolated channel impulse response from the first sensing signal based at least in part on a first arrival tap that corresponds to an earliest detected arrival tap, wherein the first interpolated channel impulse response is interpolated in a time domain

25. The apparatus of claim 24, wherein the one or more processors are further configured to transmit the second sensing signal at a second arrival tap that is after the first arrival tap.

26. The apparatus of claim 25, wherein the one or more processors are further configured to:
estimate the first interpolated channel impulse response based at least in part on transmitting the first sensing signal; and
transmit, to the initiator network node, an indication of the first interpolated channel impulse response.

27. The apparatus of claim 26, wherein the one or more processors are further configured to transmit, to the initiator network node, an indication of a first channel impulse response based at least in part on transmitting the first sensing signal, wherein the first channel impulse response is interpolated in a frequency domain

28. The apparatus of claim 27, wherein the one or more processors are further configured to transmit an indication of an offset between the first arrival tap after interpolation of the first channel impulse response, and a next sample grid point of the channel impulse response.

29. A method of wireless communication performed by an initiator network node, comprising:
transmitting a first sensing signal for sensing an object using ultra-wideband sensing;
receiving, from a responder network node, a second sensing signal, that is based at least in part on the first sensing signal, for sensing the object using the ultra-wideband sensing; and
obtaining a location of the object relative to the initiator network node and the responder network node based at least in part on the first sensing signal and the second sensing signal.

30. A method of wireless communication performed by a responder network node, comprising:
receiving, from an initiator network node, a first sensing signal for sensing an object using ultra-wideband sensing; and
transmitting, to the initiator network node, a second sensing signal, that is based at least in part on the first sensing signal, for sensing the object using the ultra-wideband sensing.
